(19) United States
(12) Patent Application Publication
(10) Pub. No.: US 2009/0322710 A1
(43) Pub. Date: Dec. 31, 2009

(54) EXTENT CALIBRATION FOR ABSOLUTE INPUT SENSORS

(75) Inventor: Eric Vandewater, Scottsdale, AZ (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: FINEPOINT INNOVATIONS, INC., Scottsdale, AZ (US)

(21) Appl. No.: 12/165,330

(22) Filed: Jun. 30, 2008

(51) Int. Cl. G06F 3/041

(52) U.S. Cl. 345/178

(57) ABSTRACT

A system and method for compensating for misalignment of a sensing surface of an absolute position input sensor is provided. In one embodiment, a first set of points is displayed on a display, the first set of points configured to represent a currently configured boundary edge. A user then traces around the physical boundary edge, and a second set of points is displayed the display, with the second set of points configured to represent the traced physical boundary edge. A user then enters a second input, and in response first set of points on the display screen is offset to align with the second set of points. From the second input, an actual boundary edge relative to the sensor surface is determined. Then, the output of the absolute position input sensor is adjusted to align with the determined actual boundary edge.

### FIELD OF THE INVENTION

The present invention generally relates to user interfaces for electric devices, and more specifically relates to absolute position input sensors.

### BACKGROUND

Absolute position input sensors are a type of input devices commonly used in a variety of different electronic systems, including computers (e.g., laptop computers, tablet computers, personal digital assistants) and communication devices (e.g., mobile phones, wireless handheld communication devices). Absolute position input sensors receive input from a user on a sensing surface and provide data to the electronic system in the form of absolute position information. Examples of absolute position information sensors include digitizer tablets (also referred to as graphics tablets, graphics pads or drawing tablets). Digitizer tablets include a sensing surface upon which a user can enter input using a stylus, such as a pen-like drawing apparatus. The output generated by the graphics tablet corresponds to the absolute position of the stylus on the surface, typically in the form of X and Y coordinate information.

In a typical application the sensing surface of the absolute position input device is mounted inside a case or housing, with the boundaries of the usable sensing surface defined by a bezel or other edge feature. Furthermore, in some applications the sensing surface of the absolute position input device is mounted with an overlapping display. In these applications the sensing surface is typically positioned behind the LCD screen. A common application of this arrangement is the tablet PC, where the display screen and underlying sensing surface provide the main user interface for the device, allowing the user to activate icons, move a cursor, and enter text and other data by applying and/or moving an appropriate stylus on the sensing surface.

In any of these cases, it is important for the alignment of the absolute position input device to be properly calibrated. Specifically, properly mapping coordinates reported by the input device to the corresponding locations of the output device. In general, this type of calibration is referred to as extent calibration, as it involves the proper mapping of the range of input values to the physical range of the output device.

Extent calibration can be performed at various different times. For example, extent calibration can be performed as part of product development. In this case, the different physical characteristics of the sensing surface are accounted for in the product integration process. This type of extent calibration thus occurs during the design of the product.

As another example, extent calibration can be performed during or after manufacturing. During manufacturing additional misalignment can occur, giving rise to the need for calibration after assembly. In the past however, extent calibration has not been commonly performed after assembly. Instead, the systems rely upon precise physical alignment of the input device surface to the housing and/or display screen. This approach has limited effectiveness, and thus is not sufficient for many applications that require higher precision.

Thus, what is needed is an improved system and method for extent calibration in absolute input devices.

### SUMMARY

A system and method for compensating for misalignment of a sensing surface in an absolute position input sensor is provided. In one embodiment, a first set of points is displayed on a display, the first set of points configured to represent an estimated boundary edge. A user then traces around the physical boundary edge, and a second set of points is displayed on the display, with the second set of points configured to represent the traced physical boundary edge. A user then enters a second input, and in response first set of points on the display screen is offset to align with the second set of points. From the second input, an actual boundary edge relative to the sensor surface is determined. Then, the output of the absolute position input sensor is adjusted to align with the determined actual boundary edge. Because this method can be performed after final assembly of the device, it can compensate for any misalignment that occurs as a result of that assembly. Thus, any misalignment between the absolute position input sensor surface and the display screen is compensated for.

In one particular embodiment, the system and method is used to compensate for misalignment between a sensing surface and an overlapping display screen. In this embodiment, the estimated, physical and actual boundary edges correspond to those edges of a display screen. Thus, a user traces around the physical boundary edge of the display screen, and the displayed second set of points are configured to represent the traced physical boundary edge of the display screen. A user then enters a second input, and in response first set of points on the display screen is offset to align with the second set of points. From the second input, an actual boundary edge of the display screen relative to the sensor surface is determined. Then, the output of the absolute position input sensor is adjusted to align with the determined actual boundary edge of the display screen.

In one embodiment, the output of the absolute position input sensor is adjusted by reporting new minimum output values and maximum output values, where those new values are generated from the determined actual boundary edge of the display screen relative to the sensor surface.

### BRIEF DESCRIPTION OF THE DRAWINGS

The present invention may more readily be described by reference to the accompanying drawings in which:

FIG. 1 is schematic representation of an exemplary tablet computer that includes an absolute position input device and an overlapping display;

FIG. 2 is schematic representation of exemplary sensing surface showing alignment with boundary edges;

FIG. 3 flow diagram of a compensation method in accordance with an embodiment of the invention;

FIGS. 4-8 are schematic views of a exemplary tablet computer that includes an absolute position input device and an overlapping display; and

FIG. 9 is a schematic view of an exemplary computer system in accordance with an embodiment of the invention.

### DETAILED DESCRIPTION

A system and method for compensating for misalignment of absolute position input sensor is provided. The system and method can be applied to any type of absolute position input sensor, including digitizer tablets (also referred to as graphics tablets, graphics pads or drawing tablets). In these absolute position input sensors, a sensing surface is provided upon which a user can draw using a stylus, such as a pen-like drawing apparatus. The output generated by the graphics tablet corresponds to the absolute position of the stylus on the surface, typically in the form of X and Y coordinate information. The system and method facilitates compensation for misalignment that exists after final assembly of the device, and thus can compensate for any misalignment in the sensing surface that occurs as a result of that assembly.

In one embodiment, a first set of points is displayed on a display, the first set of points configured to represent an initial estimated boundary edge. A user then traces around the physical boundary edge, and a second set of points is displayed on the display, with the second set of points configured to represent the traced physical boundary edge. A user then enters a second input, and in response first set of points on the display screen is offset to align with the second set of points. From the second input, an actual boundary edge relative to the sensor surface is determined. Then, the output of the absolute position input sensor is adjusted to align with the determined actual boundary edge. Because this method can be performed after final assembly of the device, it can compensate for any misalignment that occurs as a result of that assembly. Thus, any misalignment between the absolute position input sensor surface and the display screen can be compensated for.

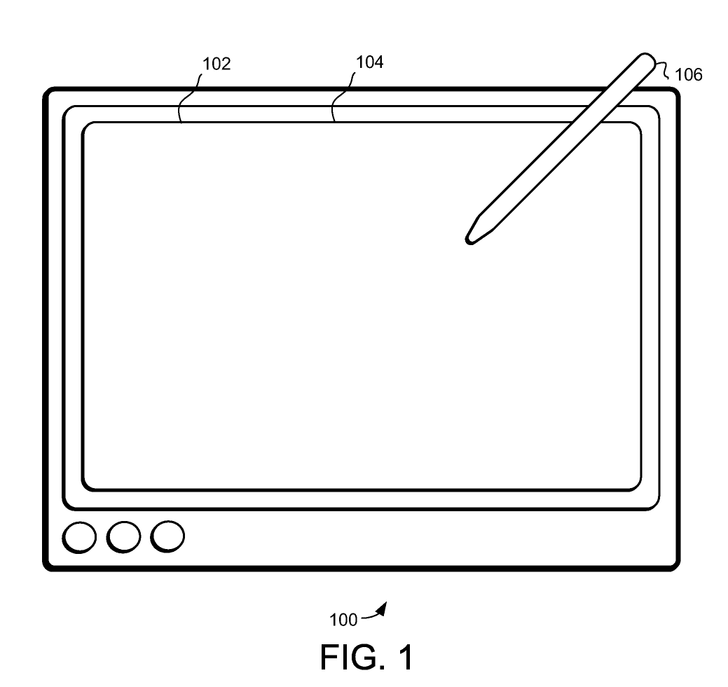

Turning now to FIG. 1, an exemplary tablet computer 100 is illustrated. The tablet computer 100 includes display 102 that overlays a sensing surface 104. The sensing surface 104 is part of an absolute position input sensor that accepts user input made with a transducer, and typically includes a plurality of loops or other electrodes configured determine the absolute position of the transducer. The absolute position of the transducer is reported to the computer, which responds accordingly. In this illustrated embodiment, the transducer comprises a stylus 106. During operation, a user can thus use the stylus 106 and the sensing surface 104 to perform a variety of user interface functions, such as activating icons, moving a cursor, and entering text and other data.

While the illustrated embodiment shows a tablet computer, it should be noted that the embodiments of the invention can be applied to any type of system or device that utilizes an absolute position input sensor as an input device.

As one specific example of the type of absolute position input sensor that can be calibrated using the embodiments of the invention, the input sensor can comprise a combination of surface and transducer such as was described in U.S. patent application Ser. No. 10/598,460, filed Aug. 31, 2006, published as U.S. Patent Application Publication No 2007/0177533. In this embodiment, the absolute position input sensor utilizes a sensing surface having both transmit and data signal capability. The surface can be implemented to operate with a number of different types of transducers, including pens (e.g., stylus 106), pointers, cursors, pucks, mice, pawns, implements and similar items. In one particular case, the transducer receives both power and data from the sensing surface using a resonant circuit. The transducer stores the power, and uses it to transmit back a position resolving signal to the surface. This signal is received by position resolving coils on the surface, which resolves the transducer position, and outputs the transducer position as absolute position data to the system. Typically, the position resolving coils are arranged in both the X and Y direction to facilitate absolute position determination in both coordinate directions.

It should be noted that such a surface and transducer is only one example of the type of absolute position input sensor that can be calibrated using the techniques described herein. For example, other pen based input devices can provide absolute position information. Furthermore, various types of touch pad and touch screen sensors can provide absolute position information. Any of these absolute position input sensors that use a sensing surface can calibrated with the embodiments of the invention.

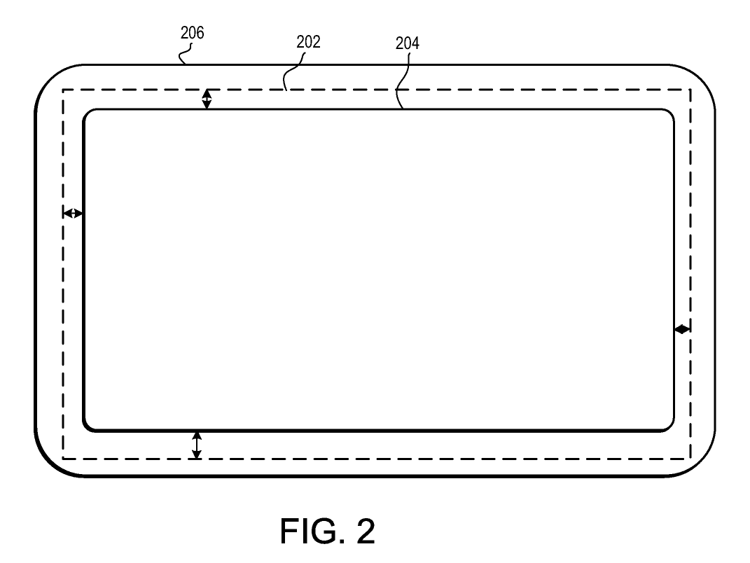

Turning now to FIG. 2, a schematic diagram illustrates how the sensing surface of an absolute position input sensor can be misaligned with boundary edges. In this example, a sensing surface 202 is mounted within a housing 206. As described above, the sensing surface typically includes the coils or electrodes used to determine the absolute position of a transducer. In this illustration, the location of the sensing surface 202 is illustrated with a dotted line. The sensing surface 202 is to be calibrated to a boundary edge 204. This boundary edge 204 can be a simple edge of the housing encasing the sensing surface, and thus could comprise a bezel or other edge shape. In another embodiment, the boundary edge 204 is the exposed edge of overlapping display screen.

As can be seen in FIG. 2, the sensing surface 202 is not properly aligned with the boundary edge 204. In this case, the misalignment is exaggerated for purposes of illustration, but it can be seen how the extent of the sensing surface 202 does not correspond to extent defined by the boundary edge 204. One way to describe this misalignment is to note that the corners of the sensing surface 202 do not align with the corners of the boundary edge 204. In typical sensors, one corner of the sensing surface is designated as the origin, with the X and Y coordinate values of that corner being (0,0). Likewise, the opposite corner would have coordinate values that correspond to the maximum output range of the sensor. For example, a sensor could have a maximum output of (2000, 3000). As can be seen, where misalignment exists between the sensing surface 202 and the boundary edge 204, the corners of the sensing surface 202 do not correspond to the corners of the boundary edge 204. Thus, a (0,0) output from the sensor does not correspond to a stylus input at a corner of the boundary edge.

This is problematic as the X and Y coordinate data provided by the sensing surfaced will not accurately correspond to either the bezel or the overlapping display screen. This is especially problematic for display screen applications, as the system needs to know the alignment of the display screen to the sensitive surface to properly interact with a user. Specifically, if there is an unaccounted for misalignment, then attempts by a user to utilize a stylus to activate an icon or other user interface element on displayed on the screen could be unsuccessful, as the system may interpret the location of the stylus as being offset from the icon, when in fact, to the perception of the user the icon is directly touched by the stylus.

As described above, the misalignment between the boundary edge 204 and the sensing surface 202 can be created by a variety of factors, including simple manufacturing variations that are within normal tolerances. In any case, the system and method provide a technique to extent calibrate the system to compensate for this misalignment, and thus can insure accurate operation of the absolute position sensor.

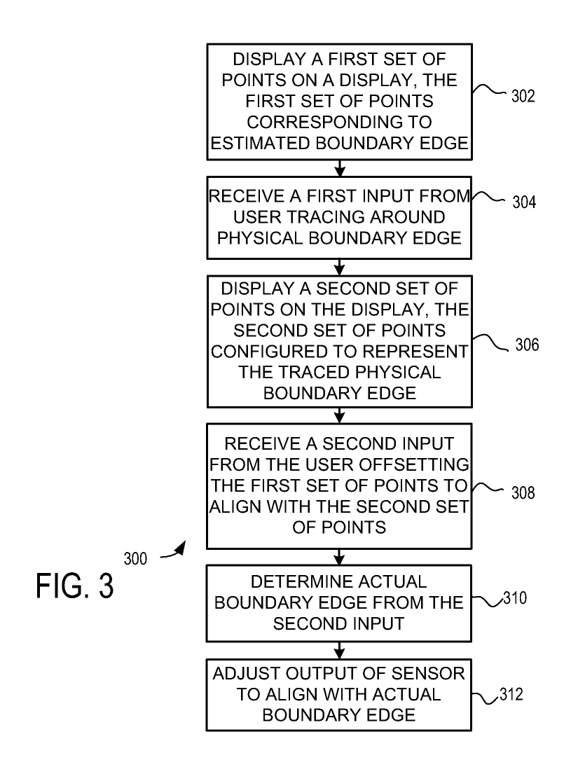

Turning now to FIG. 3, a method 300 for compensating for misalignment of a sensing surface of an absolute position input sensor is illustrated. The method 300 would typically be used by those configuring a computer system after assembly. Thus, a device manufacturer can use the method 300 to calibrate the sensor after assembly but before the device is packaged and delivered. In another application, the method can be made available to the end user, allowing the end user of a computer system to calibrate the sensor as needed. In another application, the method is used as part of the design and integration process. In any of these applications, the method 300 is performed when misalignment of the sensing surface is to be compensated for. It should also be noted that the method 300 will typically be implemented in a computer system, with the computer programmed to perform the steps of method 300.

The first step 302 of method 300 is to display a first set of points on a display, the first set of points corresponding to an estimated boundary edge. As described above, the estimated boundary edge represented by the first set of points can comprise an edge of the housing, an edge of the display screen, or some combination thereof. Furthermore, in many cases the edge of display screen would be the visible edge, not the actual edge that may be under a bezel or other structure. Stated another way, the estimated boundary edge corresponds to any edge on the system that sensing surface is to be calibrated as aligned with.

The estimated boundary edge represents the current configuration of the sensing surface, and a variety of different ways can be used to generate the estimated boundary edge. In one implementation, the estimate is merely an initial guess at what the location of the boundary edge. For example, the estimated boundary edge can be based on the assumption that the sensing surface is properly aligned with the boundary edge. In a specific example, it can be assumed that the sensing surface and the boundary edge are both the same size and are properly aligned. In other applications, the estimated boundary edge is determined from a previous alignment procedure.

The set of points displayed to represent the estimated boundary edge can comprise any suitable visual indication configured to represent the estimated boundary edge. In some embodiments, the set of points forms a line for each boundary edge, but other visual indications of the boundary edge could also be used. For example, dashes or specialized icons can be used to represent the estimated boundary edge.

The set of points can be displayed on any suitable display screen. For example, it can be displayed on a display screen of a separate computer being used to calibrate sensing the surface. In this case, the method could be implemented and run on a calibration computer set up exclusively for this purpose. In another case, the set of points can be displayed on a display screen of the device being calibrated. For example, in a tablet computer application where the sensing surface is being calibrated to a boundary edge of an overlapping display screen, the first set of points can be displayed on that same display screen. Again, this is just one example, and even in this application a separate display can instead be used.

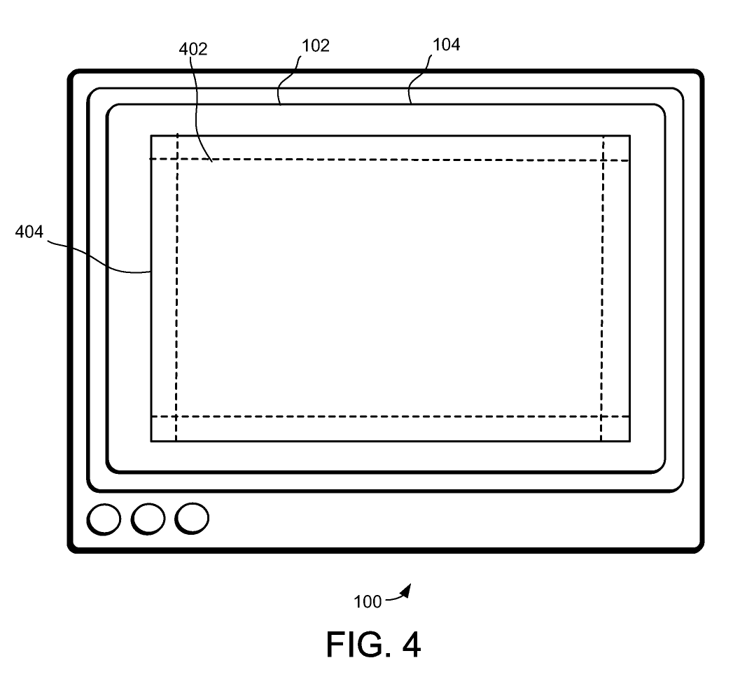

Turning now to FIG. 4, the exemplary tablet computer 100 is again illustrated, with the tablet including a display 102 that overlays a sensing surface 104. The sensing surface 104 is again part of an absolute position input sensor that accepts user input made with a transducer. In the example of FIG. 4, a set of points 402 is displayed on the display screen 102, with the set of points 402 configured to correspond to an estimated boundary edge. In this illustrated example, the estimated boundary edge that is represented is the boundary edge of the display screen 102. Furthermore, in this embodiment the set of points is displayed on that same display 102. Thus, this is an example of a configuration that would be useful for calibration of the sensor by an end user, as it does not require the use of a separate display and/or computer for calibration. Again, the set of points could instead be displayed on a separate computer, such as one used by a manufacturer for calibration after assembly.

In the example of FIG. 4, the set of points 402 is displayed as four dashed lines, with each of the four lines corresponding to one side of the display screen 102 boundary edge. Again, this is just one example, and the set of points could comprise any visual indication of the boundary edge to the user.

In this example, the set of points 402 is displayed with in an area 404 configured to represent the physical output range of the sensor. While this is not required, displaying the set of points in an area that represents the current output range can provide context for the sets of points.

Returning to FIG. 3, the next step 304 in the method 300 is to receive a first input from a user tracing around a physical boundary edge. For this step, a user would typically be prompted to take a stylus or other transducer, and trace around the physical boundary edge. Preferably, the user is instructed to trace at the outermost possible path around the edge. The sensing surface determines the locations of the stylus as the user traces around, and reports those locations as coordinates on the sensing surface to the system.

The physical boundary edge that is traced is that edge to which the sensing surface is being calibrated, and again can comprise a boundary edge of the housing, bezel, or display screen.

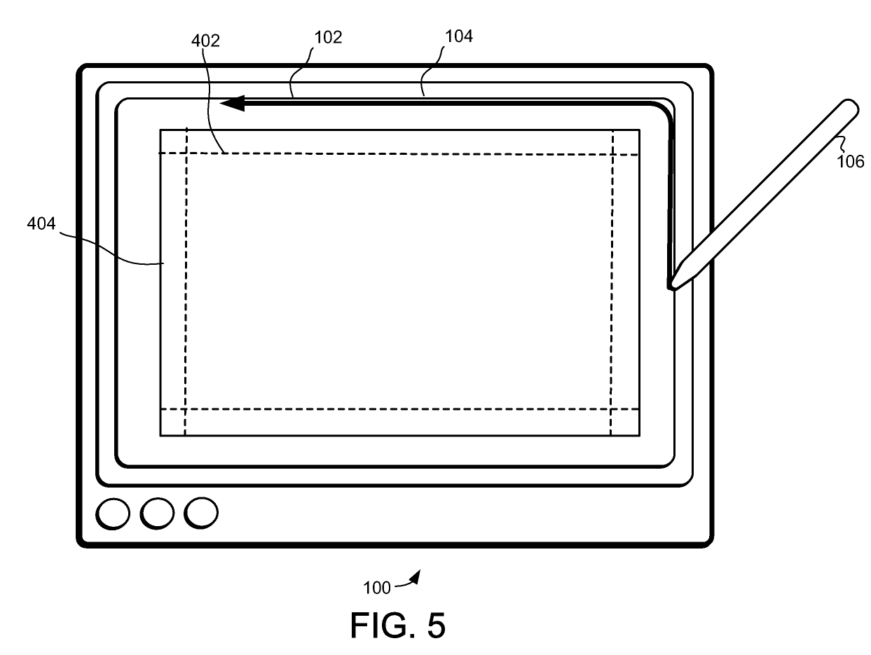

Turning now to FIG. 5, the exemplary tablet computer 100 is again illustrated. In this FIG, the user tracing of the boundary edge of display screen 102 with stylus 106 is illustrated. Typically, the user would trace around the entire boundary edge in one motion, while the system recorded the positions of the tracings on the sensing surface. However, the system could be implemented such that each side of the boundary edge is traced in a separate step, or some other variation. In another embodiment, the user does not trace around the entire boundary edge, and instead only traces selected portions, such as areas proximate the corners or selected sides.

Returning to FIG. 3, the next step 306 in the method 300 is to display a second set of points on a display, the second set of points corresponding to the traced physical boundary edge. As described above, the sensor reports the positions of the stylus tracing around the physical boundary edge. The system takes these reported positions and displays the second set of points corresponding to the reported positions. Because the user traced around the physical boundary edge, these reported positions correspond relatively precisely with the effective boundary edge of display screen or whatever boundary is being traced, and can be used to calibrate the output of the sensor to that same boundary.

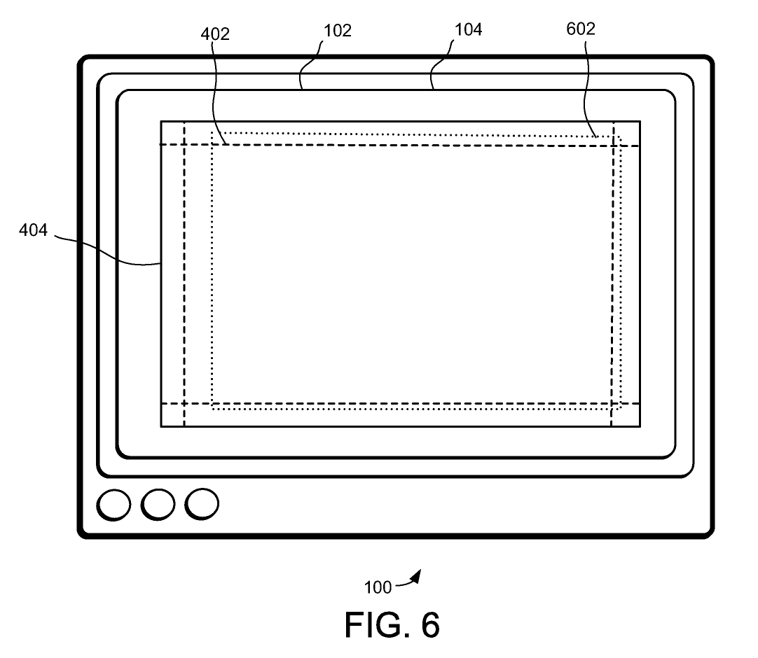

Turning now to FIG. 6, the exemplary tablet computer 100 is again illustrated, with the tablet including a display 102 that overlays a sensing surface 104. In the example of FIG. 6, a second set of points 602 is also displayed on the display screen 102, with the second set of points 602 configured to corresponding to the traced physical boundary edge. In this illustrated example, the traced boundary edge that is represented is again the traced boundary edge of the display screen 102. Furthermore, in this embodiment the set of points is displayed on that same display 102.

In the example of FIG. 6, the set of points 602 is implemented as four lines, with each of the four lines corresponding to one side of the traced display screen 102 boundary edge. Again, this is just one example, and the set of points could comprise any visual indication of the traced boundary edge to the user. It should be noted that these lines are not typically precisely straight, given that there will be some variation in the users movement and the sensors ability to accurate track the path of the trace that close to the edge.

Returning to FIG. 3, the next step 308 in the method 300 is to receive a second input from the user, where the second input offsets the first set of points to align with the second set of points. In this step, the system is configured to prompt the user to provide the second input, and in response, to align the first set of points with the second. The input from the user can be received in a variety of ways. For example, through the use of a pointing device or other cursor control, the user can select and drag the first set of points to align with the second. This would typically be done for each edge individually, with the user dragging each line of the first set to align with the corresponding line of the second set. Alternatively, specialized input buttons could be displayed that would allow the user to incrementally move the lines of the first set toward the second set. As another alternative, the system can be configured to automatically align the first set of points with the second set when prompted by the user. Furthermore, such a system can use a variety of different algorithms to calculate the appropriate alignment. Of course, these are just examples of the types of inputs that can be configured to be received by a user for aligning the first set of points with the second.

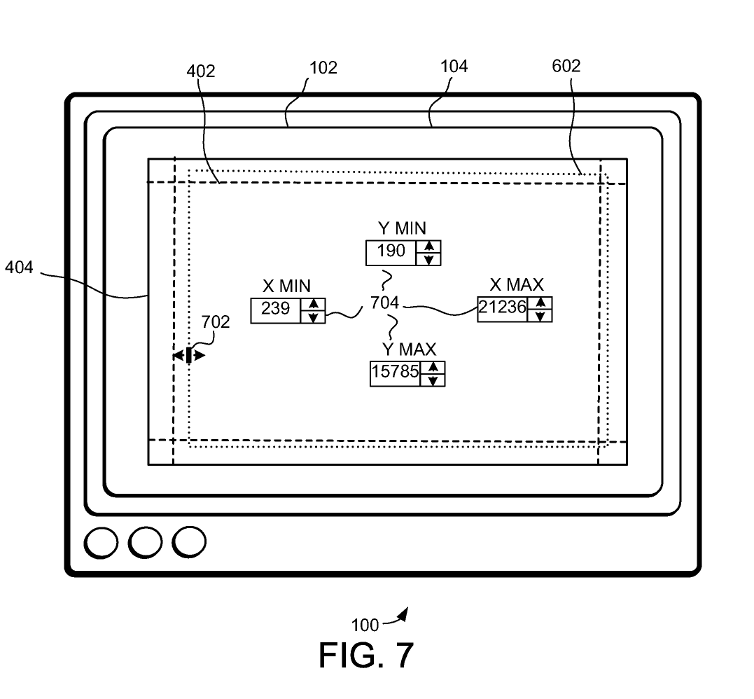

Turning now to FIG. 7, the exemplary tablet computer 100 is again illustrated, with the tablet including a display 102 that overlays a sensing surface 104. In the example of FIG. 7, a first set of points 402 is being aligned with the second set of points 602 by selecting and dragging the appropriate set of data using a cursor 702. Also illustrated in FIG. 7 are four input elements 704. Each input element 704 corresponds to one side of the traced boundary edge, and thus can be used to move each of the corresponding sets of points by activating the increase/decrease buttons. Specifically, a user can press the “increase” button for the X MAX edge and move edge corresponding to the maximum X value toward the outside, effectively increasing the maximum X value. Likewise, a user can press the “decrease” button for the Y MIN edge and move edge corresponding to the minimum Y value toward outside, effectively increasing the minimum Y value. These input elements 704 also indicate the current value of the lines, typically using the coordinates generated by the sensor.

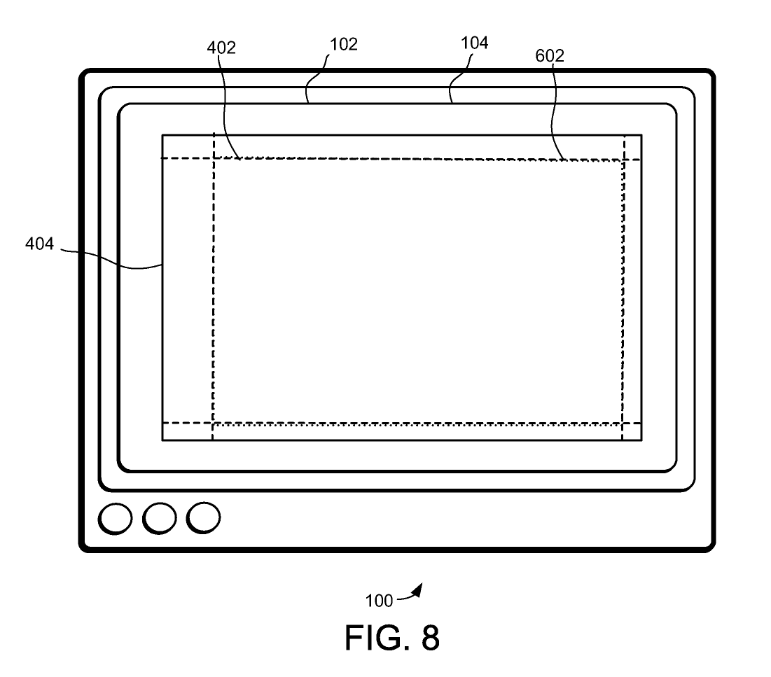

Turning now to FIG. 8, the exemplary tablet computer 100 is again illustrated, with the tablet including a display 102 that overlays a sensing surface 104. In the example of FIG. 8, each line in the first set of points 402 has been aligned with the corresponding line in the second set of points 602, as described above.

Returning to FIG. 3, the next step 310 in the method 300 is to determine the actual edge boundary from the second input. Because the second input creates a representation of the alignment between the physical boundary edge and the corresponding coordinate range of the sensor, the actual boundary edge of the sensor can be determined by taking the sensor coordinates of the input. For example, by taking the sensor coordinates of two diagonally opposite corners of the modified rectangle created by the second input. Then, when prompted by a user, the system can send this information to the input device.

The next step 312 in the method 300 is to adjust the output of the sensor to align with the actual boundary edge. In this step, the absolute position input device output is calibrated to the determined actual boundary edge. The process for doing this would typically depend on the details of the sensor.

In one application, the sensor is configured to report the determined actual boundary edges as the full output range of the sensor. For example, the input device can be reset, which triggers redetection by operating system. The operating system will then prompt for the sensor to provide its output range. The sensor will then report the determined actual boundary edges to the operating system as its full output range. Typically, this will be in the form of maximum and minimum coordinate values for the sensor, e.g., Xₛₘₐₓ, Xₛₘᵢₙ, Yₛₘᵢₙ, Yₛₘₐₓ. The system can then direct the operating system to map the calculated minimum coordinates of the sensor to the minimum coordinates of the display, and the maximum coordinates of the sensor to the maximum coordinates of the display.

The minimum and maximum coordinate values can then be used for proper mapping of coordinates inside the sensor range. For example, sensor coordinates received within the operating range of the sensor can then be properly mapped to the corresponding range of the display by using linear interpolation or similar mathematical calculations.

For example, the linear interpolation can be performed as:

$$\begin{matrix}{X}_{display} = {X}_{d min} + \frac{( {X}_{sensor} - {X}_{s min} ) * ( {X}_{d max} - {X}_{d min} )}{( {X}_{s max} - {X}_{s min} )} \\ {Y}_{display} = {Y}_{d min} + \frac{( {Y}_{sensor} - {Y}_{s min} ) * ( {Y}_{d max} - {Y}_{d min} )}{( {Y}_{s max} - {Y}_{s min} )}\end{matrix}$$

### Where

Xₛₘᵢₙ, Yₛₘᵢₙ=Minimum sensor coordinate generated during extent calibration

Xₛₘₐₓ, Yₛₘₐₓ=Maximum sensor coordinate during extent calibration

Xₛₑₙₛₒᵣ, Yₛₑₙₛₒᵣ=Current coordinate received from sensor

X_{dmin}, Y_{dmin}=Minimum display edge coordinate

X_{dmax}, Y_{dmax}=Maximum display edge coordinate

X_{display}, Y_{display}=Mapped display coordinate corresponding with sensor input

Thus, the operating system can use the maximum and minimum values generated during extent calibration to map coordinates of the input sensor to corresponding locations on the display, thereby further increasing accuracy within the sensor range.

It should be noted that after extent calibration has been performed, other calibration techniques can also be used to further improve sensor accuracy. For example, the known technique of linear calibration can be performed. In linear calibration, a set of points is displayed at known locations on the display, and a user touches each displayed point. The system then compares the locations of the touches to the known locations of the display. The difference can then be used to further adjust the mapping of points inside the sensor range to points inside the display range. It should be noted that this is not an extent calibration, as it is not adjusting the range at the boundary edges, but is instead a calibration of points in the interior of the sensor range to corresponding points in the interior of the display.

Finally, it should again be noted that because the extent calibration calculates the new output range after final assembly of the device, the use of the new output range by the operating system will compensate for any misalignment that occurs as a result of that assembly. Thus, any misalignment between the absolute position input sensor surface and the display screen is compensated for.

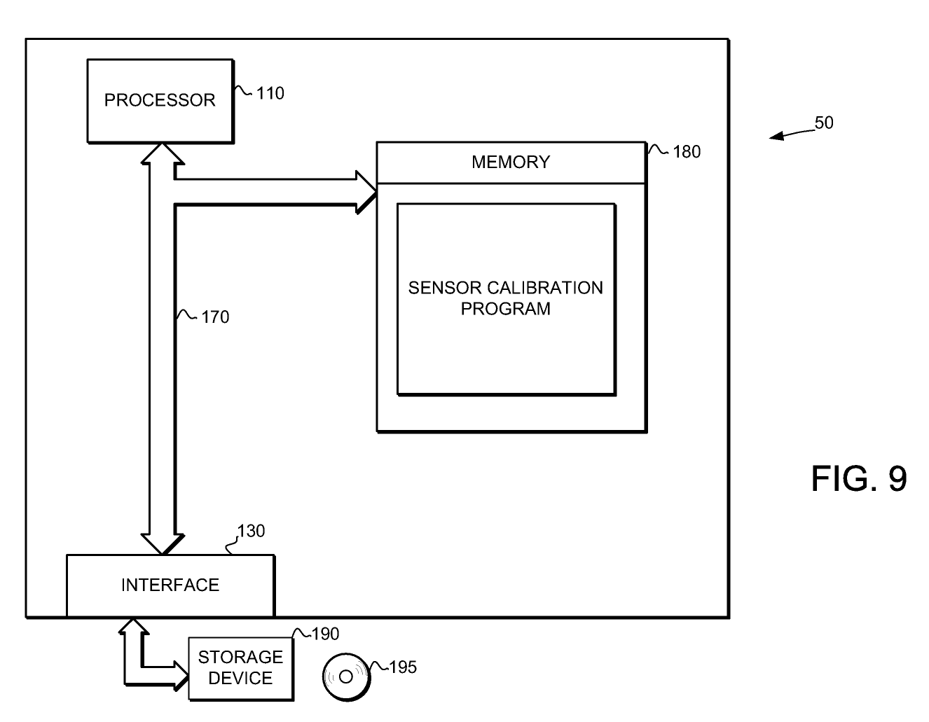

The system and method for compensating for misalignment of a sensing surface of an absolute position input sensor can be adapted to a wide variety of platforms. In one embodiment, much of the processing is implemented in a dedicated computer system used for sensor calibration. Turning now to FIG. 9, an exemplary computer system 50 is illustrated. Computer system 50 illustrates the general features of a computer system that can be used to implement the invention. Of course, these features are merely exemplary, and it should be understood that the invention can be implemented using different types of hardware that can include more or different features. The exemplary computer system 50 includes a processor 110, an interface 130, a storage device 190, a bus 170 and a memory 50. In accordance with the preferred embodiments of the invention, the memory system 50 includes a sensor calibration program.

The processor 110 performs the computation and control functions of the system 50. The processor 110 may comprise any type of processor, include single integrated circuits such as a microprocessor, or may comprise any suitable number of integrated circuit devices and/or circuit boards working in cooperation to accomplish the functions of a processing unit. In addition, processor 110 may comprise multiple processors implemented on separate systems. During operation, the processor 110 executes the programs contained within memory 180 and as such, controls the general operation of the computer system 50.

Memory 180 can be any type of suitable memory. This would include the various types of dynamic random access memory (DRAM) such as SDRAM, the various types of static RAM (SRAM), and the various types of non-volatile memory (PROM, EPROM, and flash). It should be understood that memory 180 may be a single type of memory component, or it may be composed of many different types of memory components. In addition, the memory 180 and the processor 110 may be distributed across several different computers that collectively comprise system 50.

The bus 170 serves to transmit programs, data, status and other information or signals between the various components of system 100. The bus 170 can be any suitable physical or logical means of connecting computer systems and components. This includes, but is not limited to, direct hard-wired connections, fiber optics, infrared and wireless bus technologies.

The interface 130 allows communication to the system 50, and can be implemented using any suitable method and apparatus. It can include a network interfaces to communicate to other systems, terminal interfaces to communicate with technicians, and storage interfaces to connect to storage apparatuses such as storage device 190. Storage device 190 can be any suitable type of storage apparatus, including direct access storage devices such as hard disk drives, flash systems, and optical disk drives. As shown in FIG. 9, storage device 190 can comprise a disc drive device that uses discs 195 to store data. Additionally, the interface 130 can be used to communicate with the absolute position input sensor being calibrated, as well as any displays used in the calibration.

In accordance with the preferred embodiments of the invention, the computer system 50 includes the sensor calibration program. Specifically during operation, the sensor calibration program is stored in memory 180 and executed by processor 110. When being executed by the processor 110, the calibration program receives data from the sensor, including the first and second inputs described above, and uses that data to compensate for misalignment of the sensor.

It should be understood that while the present invention is described here in the context of a fully functioning computer system, the mechanisms of the present invention are capable of being distributed as a program product in a variety of forms, and that the present invention applies equally regardless of the particular type of signal bearing media used to carry out the distribution. Examples of computer readable signal bearing media include: flash drives, hard drives, memory cards and optical disks (e.g., disk 195).

A system and method for compensating for misalignment of a sensing surface of an absolute position input sensor is thus provided. The system and method provide the ability to compensate for misalignment between the sensing surface and a display or other housing. Because this method can be performed after final assembly of the device, it can compensate for any misalignment that occurs as a result of that assembly. Thus, any misalignment between the absolute position input sensor surface and the display screen is compensated for.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

What is claimed is:

1. A method for compensating for misalignment of a sensing surface of an absolute position input sensor, the method comprising the steps of:
displaying a first set of points on a display, the first set of points configured to represent an estimated boundary edge;
receiving a first input from a user tracing around a physical boundary edge;
displaying a second set of points on the display, the second set of points configured represent the traced physical boundary edge;
receiving a second input from the user offsetting the first set of points on the display to align with the second set of points;
determining an actual boundary edge from the second input;
adjusting an output of the absolute position input sensor to align with actual boundary edge.

2. The method of claim 1 wherein the estimated boundary edge comprises an estimated boundary edge of a display screen overlapping the sensing surface, wherein the physical boundary edge comprises a physical boundary edge of the display screen, and wherein the actual boundary edge comprises an actual boundary edge of the display screen.

3. The method of claim 1 wherein the estimated boundary edge comprises an estimated boundary edge of a housing in which the sensing surface is mounted, wherein the physical boundary edge comprises a physical boundary edge of the housing, and wherein the actual boundary edge comprises an actual boundary edge of the housing.

4. The method of claim 1 wherein the step of adjusting an output of absolute position input sensor comprises:
reporting new maximum output values and minimum output values for the absolute position input sensor to an associated system.

5. The method of claim 1 wherein the reported new maximum output value and the reported new minimum output value corresponds to the actual boundary edge.

6. The method of claim 1 wherein the step of displaying a first set of points on the display comprises:
displaying a first plurality of lines, and wherein the step of displaying a second set of points on the display screen comprises displaying a second plurality of lines.

7. The method of claim 1 wherein the step of receiving a second input from the user offsetting the first set of points on the display to align with the second set of points comprises:
a user selecting and dragging the first set of points to align with the second set of points.

8. The method of claim 1 wherein the step of determining an actual boundary edge from the second input comprises:
determining a position of the actual boundary edge using a location of the offset first set of points.

9. The method of claim 1 wherein the step of receiving a second input from the user offsetting the first set of points on the display to align with the second set of points comprises:
a user activating an input button to move the first set of points to align with the second set of points.

10. The method of claim 1 wherein the absolute position input sensor comprises a digitizer tablet.

11. A method for compensating for misalignment of a sensing surface of an absolute position input sensor and a display screen, the method comprising the steps of:
displaying a first set of points on a display, the first set of points configured to represent a currently configured boundary edge of the display screen;
receiving a first input from a user tracing around a physical boundary edge of the display screen;
displaying a second set of points on the display, the second set of points configured to represent the traced physical boundary edge of the display screen;
receiving a second input from the user, and offsetting the first set of points on the display screen to align with the second set of points in response to the second input;
determining an actual boundary edge of the display screen relative to the sensing surface from the second input;
adjusting an output of the absolute position input sensor to align with actual boundary edge.

12. The method of claim 11 wherein the step of adjusting an output of absolute position input sensor comprises:
reporting new maximum output values and minimum output values for the absolute position input sensor to an associated system, wherein the reported new maximum output value and the reported new minimum output value corresponds to the actual boundary edge of the display screen.

13. The method of claim 11 wherein the step of determining an actual boundary edge of the display screen relative to the sensing surface from the second input comprises:
determining a position of the actual boundary edge of the display screen relative to an output range of the absolute position input sensor.

14. A program product comprising:
a) a sensing surface compensation program, the sensing surface compensation program configured to:
display a first set of points on a display, the first set of points configured to represent an estimated boundary edge;
receive a first input from a user tracing around a physical boundary edge;
display a second set of points on the display, the second set of points configured represent the traced physical boundary edge;
receive a second input from the user offsetting the first set of points on the display to align with the second set of points;
determine an actual boundary edge from the second input;
adjust an output of an absolute position input sensor to align with actual boundary edge; and
b) signal bearing media bearing said program.

15. The program product of claim 14 wherein the estimated boundary edge comprises an estimated boundary edge of a display screen overlapping the sensing surface, wherein the physical boundary edge comprises a physical boundary edge of the display screen, and wherein the actual boundary edge comprises an actual boundary edge of the display screen.

16. The program product of claim 14 wherein the estimated boundary edge comprises an estimated boundary edge of a housing in which the sensing surface is mounted, wherein the physical boundary edge comprises a physical boundary edge of the housing, and wherein the actual boundary edge comprises an actual boundary edge of the housing.

17. The program product of claim 14 wherein adjusting an output of absolute position input sensor is performed by:
reporting new maximum output values and minimum output values for the absolute position input sensor to an associated system.

18. The program product of claim 14 wherein the reported new maximum output value and the reported new minimum output value corresponds to the actual boundary edge.
